(19) United States
(12) Patent Application Publication
(10) Pub. No.: US 2025/0035529 A1
(43) Pub. Date: Jan. 30, 2025

(54) CYCLIC EPIPEDOGRAPHY MONITORING CONTACT ANGLE CHANGES IN DIPPING A MICROSPHERE INTO A LIQUID AND LIFTING FROM IT

(71) Applicant: New York University, New York, NY (US)

(72) Inventors: Iwao Teraoka, Rye, NY (US); Natalie Huiyi Luo, Brooklyn, NY (US)

(21) Appl. No.: 18/783,200

(22) Filed: Jul. 24, 2024

Related U.S. Application Data
(60) Provisional application No. 63/528,876, filed on Jul. 25, 2023.

(51) Int. Cl. G01N 13/02

(52) U.S. Cl. CPC G01N 13/02; G01N 2013/0208

(57) ABSTRACT

Cyclic epipedography is described and used to monitor the wetting characteristics of a microsphere on a stem with a liquid by tracking the level of a liquid line on sphere when the sphere is dipped into and lifted from the liquid. The level of the liquid plane at infinity changes with respect to the microsphere. Analysis of still images of a video taken with a horizontally held microscope determines the two levels. The microsphere allows viewing of the liquid line without being obscured by the meniscus the liquid forms with its container's wall. The position and shape of the CE allow the contact angle to be estimated at different stages in the dip-lift cycle. Amphiphilic aminopropylsilane may be used to make the surface conform to the environment. In air, the hydrophobic portion comes on top, while in water, hydrophilic part faces the surroundings. This conformity-caused Janus characteristics of the surface were almost absent with the hydroxylated silica and weak with the octylsilane-treated silica.

### § 1. RELATED APPLICATION(S)

The present application claims priority to U.S. Provisional Application Ser. No. 63/528,876 (referred to as “the '876 provisional” and incorporated herein by reference), titled “CYCLIC EPIPEDOGRAPHY MONITORING CONTACT ANGLE CHANGES IN DIPPING A MICROSPHERE INTO A LIQUID AND LIFTING FROM IT”, filed on Jul. 25, 2023, and listing Iwao Teraoka and Natalie Luo as the inventors. The present application is not limited by any specific requirements discussed in the '876 provisional.

### § 2. BACKGROUND OF THE INVENTION

Please note that nothing is in this section should be construed as an admission of prior art.

### § 2.1 FIELD OF THE INVENTION

The present application concerns monitoring chemical processes. In particular, the present application concerns monitoring a chemical process using a contact angle of water or a solution having a first biochemical substance with respect to a surface provided with a second biochemical substance.

### § 2.2 BACKGROUND INFORMATION

Monitoring atomic and molecular events on a surface is not as easy as observing the events in a bulk. If the surface is provided by pores, the large-surface-area per volume may allow monitoring, but it is difficult with a nonporous surface. Different methods have been utilized, but the contact angle has not been used. (See, e.g., the article, Alexander, M. R.; Williams, P., “Water contact angle is not a good predictor of biological responses to materials,” Biointerphases 2017, 12, No. 02C201, incorporated herein by reference.) The present inventors believe that ill-defined surfaces (on atomic scales) and problems with existing experimental methods have hampered the use of the contact angles for monitoring atomic and molecular events.

### § 3. SUMMARY OF THE INVENTION

Example methods and apparatus use cyclic epipedographs, obtained during cycles of dipping a microsphere or rod into water or a solution and lifting the microsphere or rod from the water or solution, as an estimation of a contact angle (CA) used to monitor a chemical process.

An example method for monitoring a chemical process, in a manner consistent with the present description, includes: (a) receiving a previously determined set of epipedographs associated with the chemical process; (b) obtaining a current epipedograph of the chemical process; (c) comparing the current epipedograph with the set of epipedographs received to determine a contact angle; and (d) inferring a current state of the chemical process based on the contact angle. In some example implementations of the method, the acts of (b) obtaining a current epipedograph of the chemical process, (c) comparing the current epipedograph with the set of epipedographs received to determine a contact angle, and (d) inferring a current state of the chemical process based on the contact angle, are repeated.

An example apparatus for monitoring a chemical process may include: (a) a microsphere or rod having a surface provided with a first biochemical substance; (b) a transparent container for containing water or a solution having a second biochemical substance; (c) a motor for dipping and lifting the microsphere or rod from a solution held in the transparent container; and (d) a microscope positioned outside of and adjacent to the transparent container and held horizontally, configured to obtain, repeatedly, during the dipping and lifting, paired measurements of (i) vertical position (Zₘ) of a circular slice of the microsphere or rod at a waterline defined at a top or a bottom of a meniscus of water or the solution on the microsphere or rod, and (ii) a height (h) of the water plane away from the microsphere or rod. Some example apparatus further include a stem that mechanically couples the microsphere or rod with the motor.

A non-transitory computer-readable storage medium storing processor-executable code which, when executed by a least one processor, causes the at least one processor to perform any of the foregoing methods may be provided.

In some example implementations of the method, the act of obtaining a current epipedograph of the chemical process includes: (1) dipping a microsphere or rod having a surface provided with a first biochemical substance into water or a solution having a second biochemical substance, and lifting the microsphere or rod from the solution; (2) obtaining, repeatedly, during the dipping and lifting, paired measurements of (i) the vertical position (Zₘ) of a circular slice of the microsphere or rod at a waterline defined at a top or a bottom of a meniscus of the solution on the microsphere or rod, and (ii) a height (h) of the water plane away from the microsphere or rod; and (3) determining the current epipedograph from the paired measurements obtained.

In some example implementations, the microsphere or rod has a smooth surface.

In some example implementations, a diameter of the microsphere or rod is from approximately 0.2 mm to 2 mm. In some such implementations, the diameter of the microsphere or rod is from approximately 0.4 to 1 mm.

In some example implementations, the solution is held in a transparent container. In some such implementations, inner walls of the transparent container have been treated to reduce a meniscus formed by the solution with respect to transparent container. In some implementations, the inner walls of the transparent container may have been chemically modified (e.g., with a silane with hydrophobic functionality) to have the solution-air interface at around 90 degree to the surface. In some implementations, the transparent container is a square glass cuvette.

In some example implementations, the microsphere or rod is a microsphere. In some such example implementations, the microsphere is a silica microsphere.

In some example implementations, a surface of the microsphere or rod is functionalized with an aminopropyl group or compound or another silane coupling agent.

### § 4. BRIEF DESCRIPTION OF THE DRAWINGS

FIG. 1 illustrates an experimental setup for performing cyclic epipedography to observe a microsphere's wetting using an optical microscope.

FIG. 2 includes photographs of a microsphere treated with octyldimethylchlorosilane, at various stages of a dip-lift cycle in water.

FIG. 3 illustrates a front view of a microsphere touching water and a meniscus around the microsphere.

FIG. 4 illustrates profiles of meniscus around a microsphere of radius 0.3 mm and contact angle θ=60° for water plane levels from −0.8 to 0.4 mm at 0.2 mm intervals (drawn only for one side of the microsphere).

FIG. 5 illustrates a cyclic epipedogram in dipping and lifting of the microsphere. The numbers indicate, approximately, the positions of water levels for the nine microphotographs in FIG. 2.

FIG. 6 illustrates Zₘ/a, plotted as a function of h/a, for a sphere of a=0.3 mm and θ from 10 to 120° at 10° intervals.

FIG. 7 is a flow diagram of an example method for monitoring a chemical process in a manner consistent with the present description.

FIG. 8 is a flow diagram of an example method for obtaining a current epipedograph of a chemical process.

FIG. 9 is a plot of Zₘ/a vs h/a, where a is the sphere radius, for different contact angles.

FIGS. 10(a) and 10(b) illustrate estimations of the contact angle θ as a function of h and as a function of Zₘ, respectively.

FIGS. 11(a)-11(c) are cyclic epipedograms (CEs) (i.e., plots of zₘ/a as a function of h/a for different microspheres treated with different biochemical substances.

FIG. 12 illustrates atomic structures of a surface of a silica microsphere.

### § 5. DETAILED DESCRIPTION

The present disclosure may involve novel methods, apparatus, message formats, and/or data structures for monitoring a chemical process. The following description is presented to enable one skilled in the art to make and use the described embodiments, and is provided in the context of particular applications and their requirements. Thus, the following description of example embodiments provides illustration and description, but is not intended to be exhaustive or to limit the present disclosure to the precise form disclosed. Various modifications to the disclosed embodiments will be apparent to those skilled in the art, and the general principles set forth below may be applied to other embodiments and applications. For example, although a series of acts may be described with reference to a flow diagram, the order of acts may differ in other implementations when the performance of one act is not dependent on the completion of another act. Further, non-dependent acts may be performed in parallel. No element, act or instruction used in the description should be construed as critical or essential to the present description unless explicitly described as such. Also, as used herein, the article “a” is intended to include one or more items. Where only one item is intended, the term “one” or similar language is used. Thus, the present disclosure is not intended to be limited to the embodiments shown and the inventors regard their invention as any patentable subject matter described.

### § 5.1 Terminology

An “aminopropyl” is a compound containing an amino group (NH2) attached to a propyl group (—CH2-CH2-CH3). An “aminopropyl” can refer to, for example, Aminopropyl Silanes, Aminopropylamines, Aminopropyl Functionalized Polymers, etc. An “Aminopropyl Group” consists essentially of a propyl chain (—CH2-CH2-CH3) with an amino group (—NH2) attached to one end.

“Approximately {a value}” or “about {a value}” is intended to mean {the value} plus or minus ten percent (+/−10%).

A “biochemical substance” is substance that is chemical substance or agent, and/or biological substance or agent.

“Chemical Interaction” or “Chemical Process”: Refers to any interaction or process involving chemical entities, including reactions where chemical bonds are broken and formed, the formation of coordination complexes (complexation, e.g., through coordination bonds between metal ions and ligands), and the stable association of molecules through various types of interactions (covalent or non-covalent) (binding).

“Chemical Reaction”: A chemical reaction involves the breaking and forming of chemical bonds between atoms to create new substances. It involves the formation of entirely new substances through the rearrangement of atoms and electrons.

Characteristics of a chemical reaction include, for example, that it:
involves the rearrangement of atoms and electrons;
results in the formation of entirely new chemical entities with distinct properties from the reactants;
is typically irreversible under normal conditions;
is often accompanied by the release or absorption of energy (exothermic or endothermic).
Examples of chemical reactions include, for example, combustion, oxidation-reduction reactions (redox reactions), acid-base reactions, and synthesis of organic compounds.

“Complexation”: refers to the formation of complexes, which are coordination compounds (complexes) formed by the association of a metal ion with one or more ligands (atoms, ions, or molecules that donate electron pairs to the metal ion). It is typically reversible and does not involve the creation of new chemical entities.

Characteristics of complexation include, for example, that it:
involves the interaction between a metal ion and ligands through coordination bonds (coordinate covalent bonds);
does not involve the formation of new chemical substances with different properties from the individual components (metal ion and ligands retain their identities);
is reversible process where complexes can dissociate back into metal ions and ligands;
can occur in aqueous or organic solvents.
Examples of complexation include, for example, formation of metal complexes with ligands such as ammonia (e.g., [Cu(NH3)4]2+), EDTA (ethylenediaminetetraacetic acid), crown ethers, etc.

“Binding”: refers broadly to the interaction between molecules or molecular entities (e.g., proteins, enzymes, ligands) resulting in a stable association. It may involve various types of interactions (covalent or non-covalent), and often reversible.

Characteristics of binding include, for example, that it:
can involve non-covalent interactions (e.g., hydrogen bonding, van der Waals forces, hydrophobic interactions) or sometimes covalent bonds;
may or may not involve a change in chemical structure or composition of the molecules involved;
is often reversible, depending on the strength of the binding interactions. can occur between molecules of the same type (homotypic binding) or different types (heterotypic binding).
Examples of binding include, for example binding of ligands to receptors (e.g., drug-receptor binding), protein-protein binding, enzyme-substrate binding, DNA-protein binding, and host-guest interactions in supramolecular chemistry.

The “contact angle” is the angle at the interface where water, air and solid meet, and its value is a measure of how likely the surface is to be wetted by the water. Therefore, low contact-angle values demonstrate a tendency of the water to spread and adhere to the surface (and the surface can be said to be “hydrophilic”), whereas high contact-angle values demonstrates the tendency of water to be repelled by the surface (and the surface is said to be “hydrophobic”). The contact angle can also be defined for a liquid other than water or an aqueous solution.

An “epipedograph” or “epipedogram” (or a “cyclic epipedograph” or “cyclic epipedogram” (CE)) is a plot of Zₘ as a function of h in dipping and lifting a microsphere or rod from a liquid, such as water.

“Epipedography” is a process of obtaining an epipedograph (or epipedogram)

“Non-porous” or “smooth”. A surface is considered to be “smooth” if its vertical height variations over a horizontal distance are less than the horizontal distance along the surface.

A “sphere” is an ellipsoid with a flattening (in the mathematical sense) less than 0.05, and preferably less than 0.01.

### § 5.2 Overview

Example methods and apparatus use cyclic epipedographs, obtained during cycles of dipping a microsphere or rod into water or a solution and lifting the microsphere or rod from the water or solution, as an estimation of a contact angle (CA) used to monitor a chemical process.

### § 5.2.1 Contact Angle

Surface tension of a liquid and interfacial free energy of a solid or a contact angle are usually measured for a planar substrate (See, e.g.: the articles: Scheludko, A. D.; Nikolov, D., “Measurement of surface tension by pulling a sphere from a liquid,” Colloid Polym. Sci. 1975, 253, 396-403 (incorporated herein by reference); Gunde, R.; Hartland, S.; Mäder, R., “Sphere Tensiometry: A New Approach to Simultaneous and Independent Determination of Surface Tension and Contact Angle,” J. Colloid Interface Sci. 1995, 176, 17-30 (incorporated herein by reference); Champmartin, S.; Ambari, A.; Le Pommelec, J. Y., “New procedure to measure simultaneously the surface tension and contact angle,” Rev. Sci. Instrum. 2016, 87, No. 055105 (incorporated herein by reference); and Extrand, C. W.; Moon, S. I., “Contact Angles on Spherical Surfaces,” Langmuir 2008, 24, 9470-9473 (incorporated herein by reference).) but nonplanar geometries have also been used successfully. For example, a Noüy ring uses a cut of a hollow cylinder to measure the surface tension. Use of a sphere demonstrated a high accuracy in estimating the surface tension (See, e.g.: the article, Yang, L.; Tu, Y.; Fang, H., “Modeling the rupture of a capillary liquid bridge between a sphere and plane,” Soft Matter 2010, 6, 6178-6182 (incorporated herein by reference); the article, Horváth, I. T.; Colinet, P.; Vetrano, M. R., “Measuring contact angles of small spherical particles at planar fluid interfaces by Light,” Appl. Phys. Lett. 2016, 108, No. 201605 (incorporated herein by reference); and the text, Morrison, I. D.; Ross, S. Colloidal Dispersions: Suspensions, Emulsions, and Foams; Wiley: New York, 2002 (incorporated herein by reference).) as well as the contact angle (See, e.g.: the article, Horváth, I. T.; Colinet, P.; Vetrano, M. R., “Measuring contact angles of small spherical particles at planar fluid interfaces by Light,” Appl. Phys. Lett. 2016, 108, No. 201605 (incorporated herein by reference); the text, Morrison, I. D.; Ross, S. Colloidal Dispersions: Suspensions, Emulsions, and Foams; Wiley: New York, 2002 (incorporated herein by reference); the article, Hebbar, R. S.; Isloor, A. M.; Ismail, A. F. “Contact Angle Measurements,” Membrane Characterization; Hilal, N.; Ismail, A. F.; Matsuura, T.; Oatley-Radcliffe, D., Eds.; Elsevier, 2017; pp 219-255 (incorporated herein by reference); the article, Huhtamaki, T.; Tian, X.; Korhonen, J. T.; Ras, R. H. A. “Surface wetting characterization using contact-angle measurements,” Nat. Protoc. 2018, 13, 1521-1538 (incorporated herein by reference.); and the article, Drelich, J. W.; Boinovich, L.; Chibowski, E.; Volpe, C. D.; Hołysz, L.; Marmur, A.; Siboni, S., “Contact angles: history of over 200 years of open questions,” Surf. Innovations 2020, 8, 3-27 (incorporated herein by reference).). These methods measure the force acting on the ring or the sphere, as weight measurement is one of the most accurate methods. As the force on the sphere is proportional to a^{b}, where a is the sphere's radius and the exponent b is between 2 and 3, a large sphere is usually used. Here, “large” means that a is much greater than the characteristic length of the meniscus of the liquid, (ρg/γ)^{-1/2}, where ρ is the density of the liquid, g is acceleration by gravity, and γ is the surface tension. If a>>(ρg/γ)^{-1/2}, the sphere's surface is essentially flat. For water at 20° C., (ρg/γ)^{-1/2}=2.72 mm.

### § 5.2.2 Contact Angle with a Sphere Dipped and Removed from a Liquid, Such as Water or a Solution

When a sphere with a uniform surface touches water, the water rises along the sphere's surface, forming a circular water line. The height of the water line is determined by the surface energy of the sphere and the potential energy of the water lifted or depressed. The present application describes the water's rise for spheres with a<(ρg/γ)^{-1/2} and provides examples of estimating the contact angle from the rise. Weight measurement is impractical for small spheres, but they have advantages that large spheres do not have. First, imaging the sphere and the meniscus line of water around the sphere is relatively easy. Second, nearly perfect spheres (having low flattening, and a smooth surface on atomic scales) can be easily fabricated from silica optical fibers. The flattening was evaluated from the spacing between adjacent resonance peaks of whispering gallery mode. (See, e.g., the article, Teraoka, I., “Resonance shifts of transverse-electric whispering gallery modes in a spheroidal resonator,” Appl. Opt. 2012, 51, 1101-1108 (incorporated herein by reference).) See also section 1 in the Appendix for details. Third, the container of the fluid can be small, and a standard spectrometer cuvette can be used. However, its interior surface should be chemically modified to suppress the meniscus at the cuvette's walls. Easy availability of good spheres allows a study of the effect of surface modification on the contact angle. It is also possible to monitor the change of the contact angle with the progress of reaction on the surface or binding of molecules to surface-bound moieties. As the contact angle is determined by the top surface exposed to water, wetting characteristics sensitively reflect the chemical process on the top surface.

### § 5.2.3 Epipedography and Example System for Performing Epipedography

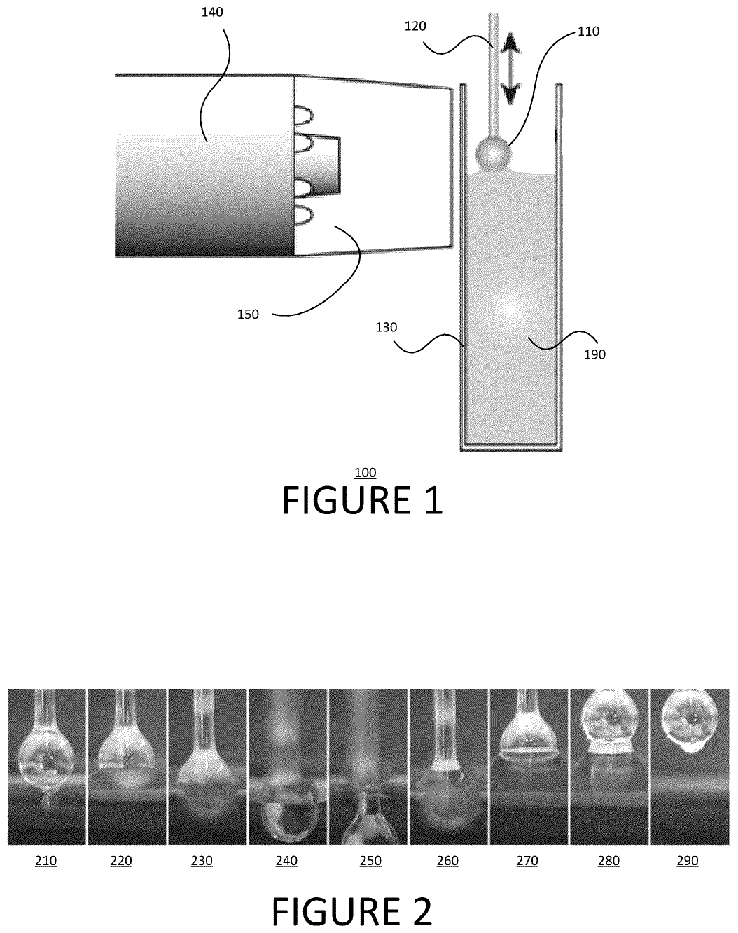

FIG. 1 illustrates example components of an example measurement system 100. As shown, the example system 100 includes a silica microsphere (e.g., with a diameter of about 0.5-0.6 mm) 110 on a stem (e.g., with a diameter of about 0.20 mm) 120. The stem 120 is attached to a vertical translation stage (not shown) with the microsphere 110 at the low end. The vertical translation stage allows the microsphere 110 to be lowered and raised. More specifically, the microsphere is dipped into and lifted from water in a (e.g., about 10 mm) square glass cuvette 130. An interior surface of the cuvette 130 is preferably treated with octylsilane to suppress the meniscus at the walls of the cuvette 130. A horizontally placed microscope 140 monitors the contact of the microsphere 110 with the water 190, and records the dipping-lifting event. The microscope 140 is provided with a (e.g., LED) lighting source 150.

Although not shown in FIG. 1, a general purpose computer, and/or application-specific processor(s) may be provided to (1) control the dipping and lifting, (2) capture images from the microscope, (3) process the images captured, (4) determine one or more cyclic epipedograms (CEs) from the images, and/or (5) determine a contact angle from a comparison of a current CE with a set of known CEs. For example, a machine may be used to perform one or more of the processes described, and/or store information used and/or generated by such processes. The example machine may include one or more processors, one or more input/output interface units, one or more storage devices, and one or more system buses and/or networks for facilitating the communication of information among the coupled elements. One or more input devices and one or more output devices may be coupled with the one or more input/output interfaces. The one or more processors may execute machine-executable instructions (e.g., C or C++ running on the Linux operating system widely available from a number of vendors) to perform one or more aspects of the present description. At least a portion of the machine executable instructions may be stored (temporarily or more permanently) on the one or more storage devices and/or may be received from an external source via one or more input interface units. The machine executable instructions may be stored as various software modules, each module performing one or more operations. Functional software modules are examples of components of the present description.

In some example embodiments consistent with the present description, the processors may be one or more microprocessors and/or ASICs. The bus may include a system bus. The storage devices may include system memory, such as read only memory (ROM) and/or random-access memory (RAM). The storage devices may also include a hard disk drive for reading from and writing to a hard disk, a magnetic disk drive for reading from or writing to a (e.g., removable) magnetic disk, an optical disk drive for reading from or writing to a removable (magneto-) optical disk such as a compact disk or other (magneto-) optical media, or solid-state non-volatile storage. Some example embodiments consistent with the present description may also be provided as a machine-readable medium for storing the machine-executable instructions. The machine-readable medium may be non-transitory and may include, but is not limited to, flash memory, optical disks, CD-ROMs, DVD ROMs, RAMS, EPROMS, EEPROMs, magnetic or optical cards or any other type of machine-readable media suitable for storing electronic instructions. For example, example embodiments consistent with the present description may be downloaded as a computer program which may be transferred from a remote computer (e.g., a server) to a requesting computer (e.g., a client) by way of a communication link (e.g., a modem or network connection) and stored on a non-transitory storage medium. The machine-readable medium may also be referred to as a processor-readable medium. Although not shown in FIG. 1, example embodiments consistent with the present description (or components or modules thereof) might be implemented in hardware, such as one or more field programmable gate arrays (“FPGA”s), one or more integrated circuits such as ASICs, etc. Alternatively, or in addition, embodiments consistent with the present description (or components or modules thereof) might be implemented as stored program instructions executed by a processor. Such hardware and/or software might be provided a server for example.

FIG. 2 shows nine still images of a video recording at different stages of the dip-lift cycle for a microsphere (radius 287 μm) modified with octyldimethylchlorosilane. In the fourth photo 240 and fifth photo 250, the microscope is focused on the microsphere in water, whereas all of the other photos focus on the sphere in air. The microsphere in air is lowered, and the first photo 210 is shortly before the microsphere touches the water. As soon as the microsphere touches water, the water rises on the microsphere and exhibits a meniscus line on each side of the microsphere, as shown in the second photo 220. Further lowering the microsphere raises the water line on the microsphere, but the hydrophobic surface depresses the water plane, as shown in the fourth photo 240. Eventually, the whole microsphere is engulfed in water, although the presence of the stem obscures this part, as shown in the fifth photo 250. As the microsphere is subsequently raised, it emerges from water, as shown in the sixth photo 260. The eighth photo 280 is right before the microsphere releases water. A compact pendant drop forms at the microsphere's lower side, as shown in the nineth and final photo 290. If the microsphere's surface were sufficiently hydrophilic, one would observe a broadly spread droplet. The microsphere may be lowered and lifted again to repeat the cycle. Note that, in the second and subsequent dip-lift cycles, the microsphere might (and likely will) still be wet from the dipping in the earlier cycle, unless the microsphere's movement is extremely slow.

Although other surfaces (e.g., rods) can be used, one advantage of using a microsphere is that a clear front view of the water line at different stages of the dip-lift cycle, unobscured by nonhorizontal water plane or its meniscus with the cuvette's wall, is provided. The water line is often visible on the microsphere, and, if not, its level can be estimated from the curved water-air interface lines at both sides of the sphere; these meniscus lines are always sharp, as the microscope captures the crest of the concave meniscus. These advantages are lost if the dipping object is plate, for example.

The level of the water line and the profile of the tailing meniscus are a result of minimizing the free energy. The latter consists of the surface energy (sphere-water, sphere-air, and water air) and the potential energy of water above or below the water plane (were it not for the microsphere), with reference to the microsphere and water that would form a horizontal meniscus. FIG. 3 illustrates the microsphere and water in a vertical cross section through the center of the microsphere. FIG. 3 illustrates a front view of a microsphere of radius a touching water with z and r axes of cylindrical coordinates superimposed. Water forms a water line at zₘ above the water plane at z=h, r=∞. Water-air interface (meniscus) trails from the water line. The meniscus follows the Laplace equation (See, e.g., the text, Katopodes, N. D. Free-Surface Flow: Shallow Water Dynamics; Elsevier, 2018 (incorporated herein by reference).) that can be obtained by balancing the forces due to surface tension and gravity. FIG. 3 defines the cylindrical coordinates (r, z) with the origin at the sphere's center. The z coordinate of the water plane at infinity is denoted by h, and the z coordinate of the water line around the sphere is denoted by zₘ.

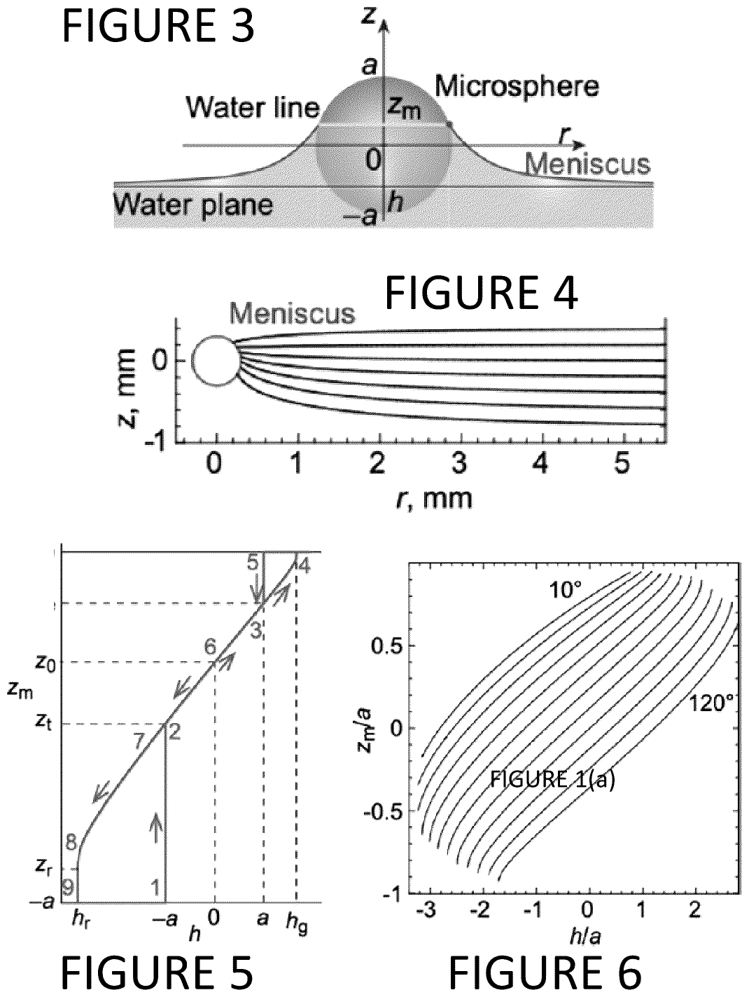

FIG. 4 shows profiles of the meniscus trailing from the microsphere's surface in a vertical plane containing the microsphere's center for different levels of the water plane. The micosphere has a radius of 0.3 mm and contact angle θ=60° for water plane levels from −0.8 to 0.4 mm at 0.2 mm intervals, drawn only for one side of the sphere. Surface tension=72.5 mN/m. The curves of the meniscus are the results of the free energy minimization. The contact angle of water at the microsphere's surface is equal to the one for a flat surface, as required. When cylindrical symmetry holds, such as a sphere with horizontal water plane, the meniscus approaches the horizontal at a shorter distance compared with (ρg/γ)^{-1/2}.

FIG. 5 illustrates how zₘ changes with h, assuming that the contact angle hysteresis (See, e.g., the article, Makkonen, L., “A thermodynamic model of contact angle hysteresis,” J. Chem. Phys. 2017, 147, No. 064703 (incorporated herein by reference.).) is absent. Thus, the plot in FIG. 5, referred to as an “epipedogram” or “epipedograph,” collapses into a curve. Note that the numbers (1-9) in FIG. 5 indicate roughly the positions of water levels for the nine photos 210-290 in FIG. 2. Referring to FIGS. 3 and 5, starting at point 1 in FIG. 5, assume the microsphere is lowered but has not touched water (h<−a). As h exceeds −a, and the microsphere touches water, the water line climbs to zₜ. Further lowering of the microsphere raises the water line on the microsphere. As shown in FIG. 2(d), the water plane's level can exceed a to depress the water around the microsphere's top. At h=h_{g}, the whole sphere is engulfed in water. Now, assume that the movement of the microsphere is reversed. As h decreases to a, the microsphere's top emerges out of water to recede the water line to a level at zₑ. Further raising the microsphere brings down the water level. As h reaches hᵣ, and concomitantly zₘ drops to zᵣ, the microsphere releases water, leaving a pendant drop at the bottom of the microsphere.

Since the microsphere has a stem that extends upward, the upper right part of the trajectory in FIG. 5 might not be observed. The use of an inverted microsphere with a downward stem may facilitate seeing the upper right portion. (The present inventors prepared such a microsphere but found that this part of the trajectory does not uncover as detailed water line-water plane relationship as the lower, left end of the trace curve does with the upward stem.)

FIG. 6 illustrates how the water line moves with the level of the water plane for different contact angles by illustrating zₘ/a, plotted as a function of h/a, for a sphere of a=0.3 mm and CA from 10 to 120° at 10° intervals. The curves were obtained due to the free energy being minimized. If wetting does not have a hysteresis, the epipedogram will follow a curve like one of those in FIG. 6. Conversely, superimposing an experimental epipedogram (e.g., a currently obtained epipedogram) onto this set of plots allows one to estimate the contact angle at different stages of the dip-lift cycle. FIG. 6 shows the level of the water line as a function of the level of the water plane, both reduced by a. The division does not remove dependence on a, but the figure is usable for a limited range of the microsphere radius (unless the water plane is extremely low or high). FIG. S3 in the Appendix compares iso-contact angle (CA) lines for a=0.25 mm with those for a=0.3 mm.

To draw an epipedogram, the system (with or without human intervention) identifies the microsphere's position, the level of the water plane, and the level of the water line on the microsphere, in each of a plurality of still images of the video recording. Details of the identification procedure are described in Section 3 in the Appendix.

### § 5.3 Example Methods for Monitoring, Using Epipedography for Example, a Chemical Process

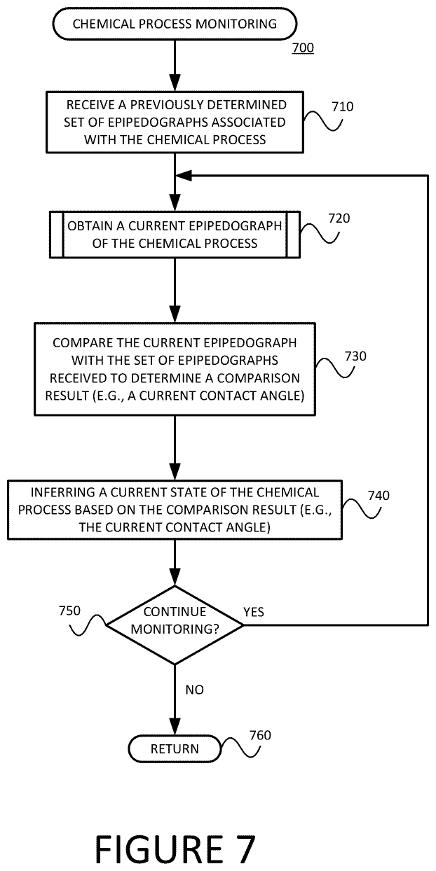

FIG. 7 is a flow diagram of an example method 700 for monitoring a chemical process in a manner consistent with the present description. As shown, a previously determined set of epipedographs (Recall, e.g., FIG. 6.) associated with the chemical process is received. (Block 710) A current epipedograph (Recall, e.g., FIG. 5.) of the chemical process is obtained. (Block 720) The current epipedograph is then compared with the set of epipedographs received to determine a contact angle (CA). (Block 730) Finally, a current state of the chemical process is inferred based on the comparison result. (Block 740)

If it is desired to continue monitoring the chemical process (Decision 750=YES), the example method 700 branches back to block 720 and the acts of obtaining a current epipedograph of the chemical process (Block 720), comparing the current epipedograph with the set of epipedographs received to determine a CA (Block 730), and inferring a current state of the chemical process based on the comparison result (Block 740), are repeated. Although not shown, there may be a delay in the loop-back (e.g., if the chemical process being monitored is slow). If, on the other hand, it is not desired to continue monitoring the chemical process (Decision 750=NO), the example method 700 is left (Return Node 760).

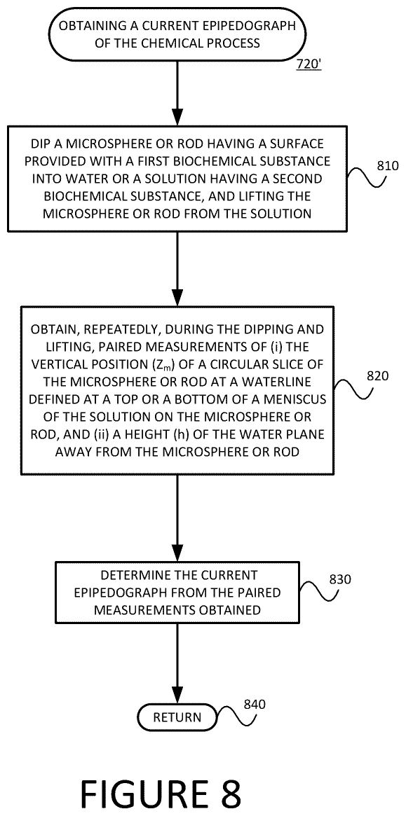

FIG. 8 is a flow diagram of an example method 720′ for obtaining a current epipedograph. As shown, a microsphere or rod having a surface provided with a first biochemical substance is dipped into water or a solution having a second biochemical substance, and the microsphere or rod is then lifted from the solution. (Block 810) During the dipping and lifting, paired measurements of (i) the vertical position (Zₘ) of a circular slice of the microsphere or rod at a waterline defined at a top or a bottom of a meniscus of the solution on the microsphere or rod, and (ii) a height (h) of the water plane away from the microsphere or rod, are obtained repeatedly. (Block 820) (Recall, e.g., points 1-9 on FIG. 5.) The current epipedograph is determined from the paired measurements obtained. (Block 830) The example method 720′ is then left (Return Node 840).

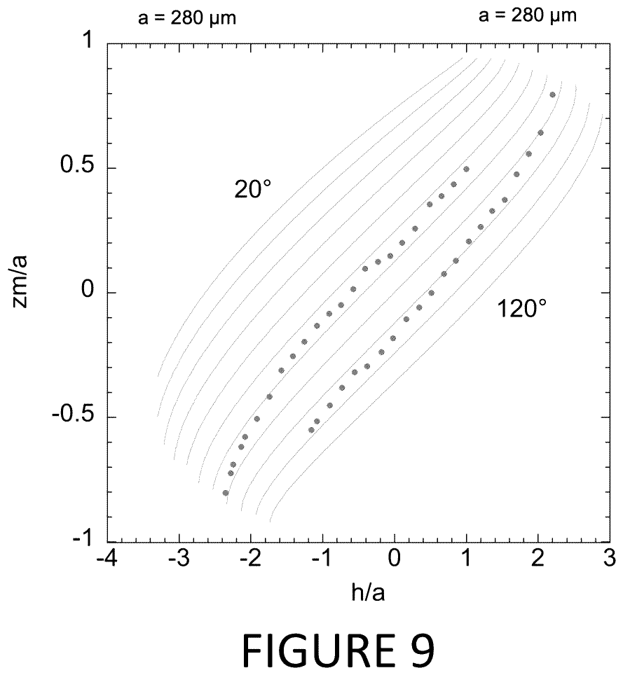

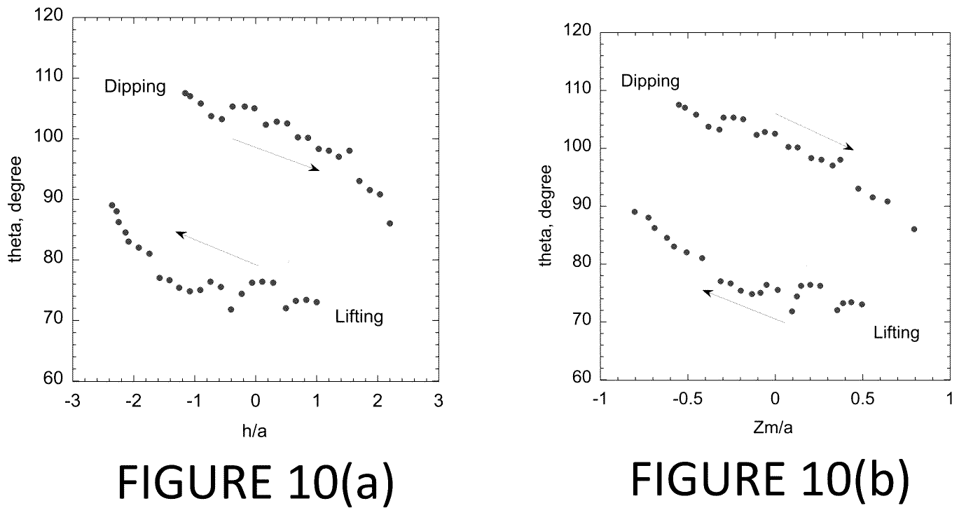

The epipedograph (a plot of Zₘ as a function of h) allows estimation of the contact angle at each state of dipping and lifting. It works as follows.
1. Solve the Laplace equation for the water-air interface in the geometry of water and a sphere of a given radius and a given contact angle. Repeat solving the equation for different contact angles but for the same radius.
2. Plot Zₘ/a vs h/a, where a is the sphere radius, for different contact angles. An example is shown in FIG. 9. Each curve in FIG. 9 represents a specific contact angle. In this example, the contact angles are from 20, to 120°, 10° apart. A microsphere radius of 280 μm is assumed.
3. Compare the experimental epipedograph (circles in FIG. 9) with the theoretical curves. The data shown are for a silica microsphere, first hydroxylated with Fenton's reagent, then modified with octyltriemthoxysilane in dodecane at 95° C. for 47 hours, followed by immersing in water for 6 hours.
4. Linear interpolation will lead to estimation of the contact angle θ as a function of h (or Zm). FIGS. 10(a) and 10(b) show the estimates.

Referring to FIGS. 10(a) and 10(b), note that there are ups and downs in the plots. However, a few features are evident. First, the contact angle is high in the dipping, and lower in the lifting. Second, the contact angle deceases as the sphere is dipped further (increasing h or Zₘ). Third, the contact angle increases as the sphere is lifted further (decreasing h or Zₘ). The first feature is consistent with the contact angle hysteresis that has an advancing contact angle higher than the receding angle. In the dipping, the water line advances; When lifted, the water line recedes. The present inventors believe that the second and third features are caused by the finite surface area of the small sphere, though further studies are needed for confirmation.

### § 5.4 Refinements, Alternatives, and Extensions

Referring back to FIG. 1, the microsphere 110 (or rod) preferably has a smooth (e.g., non-porous) surface. In some example implementations, the microsphere 110 (or rod) is silica. In some example implementations, a surface of the microsphere 110 (or rod) is functionalized with an aminopropyl group or compound or another silane coupling agent that has a functionality such as glycidyl, isocyanate, and azide.

A diameter of the microsphere or rod is from approximately 0.2 mm to 2 mm, and preferably from approximately 0.4 mm to 1 mm.

Recall from FIG. 1 that the solution 190 is held in a transparent container 130, such as a square glass cuvette for example. The inner walls of the transparent container are preferably treated to reduce a meniscus formed by the solution 190 with respect to transparent container 130. In some example embodiments, the inner walls of the transparent container 130 have been chemically modified to have the solution-air interface at around 90 degrees to the vertical wall of the container. In some implementations, the chemically modifying agent is a silane with hydrophobic functionality,

### § 5.5 Experimental Results

Some experimental results of cyclic epipedography (CE) are described in this section.

### § 5.5.1 MATERIALS AND METHODS

A microsphere was fabricated by melting the tip of a silica optical fiber (FT200EMT, ThorLabs) using electric arc, while rotating the fiber around its axis. The pristine part of the fiber served as a stem (diameter 0.20 mm) to support the microsphere. Most of the microspheres the present inventors made had a diameter between approximately 0.5 and 0.6 mm.

Surface treatment of a microsphere started with immersing it into Fenton's reagent (34% hydrogen peroxide in water, spiked with a solution of FeSO₄). In 5-10 min, the mixture bubbled vigorously and boiled by itself. Subsequently, the microsphere was immersed into a solution of a silanization agent, for example, octyldimethylchlorosilane in toluene (10 wt %) for 30 minutes.

An epipedography system, consisting of a microscope, a cuvette holder, and a fiber stem holder, was designed and fabricated in-house. A USB microscope with eight LEDs attached on front (720p, Tonha through Amazon) was mounted on a manually controlled vertical translation stage. Its focal plane was adjusted to a distance of a few millimeters into the cuvette. The image sensor had a resolution of 960×720 pixels. The USB output of the microscope was connected to a Macintosh computer. QuickTime Player recorded the video at a rate of ˜6 frames/second. Separately, the stem of a given microsphere was attached to the stem holder on three axes of translation. The vertical translation was on a stepper motor, while micrometers were manually adjusted for the other two directions. One of the micrometers was to focus the microscope onto the sphere either in air or in water. The stepper motor's driver was STSPIN220 (STMicro). A C++ program controlled the motor driver through Arduino's GPIO ports. Typically, we moved the microsphere up and down at ˜6 μm/second, unless otherwise mentioned.

The still images of a recorded video were generated using an app VLC on Macintosh and trimmed using a Python program with PIL plugins. The trimmed images were imported into an Adobe Illustrator (AI) file. The positions of the water plane, water line, and microsphere's center were determined using a Transform function of AI. The diameter of the stem was used as a reference of the length scale.

The interior of a glass cuvette (10×10 mm, id) was treated with Fenton's reagent, followed by octyldimethylchlorosilane, to minimize meniscus against water. This practice was critical to have an unmasked and undistorted image of the microsphere, water line, and water plane, and also to minimize the effect of meniscus at the cuvette's wall on the water plane.

The temperature of the water was not controlled or measured, but the air temperature near the cuvette was measured. Typically, it was around 21° C.

### § 5.5.2 Results and Discussion

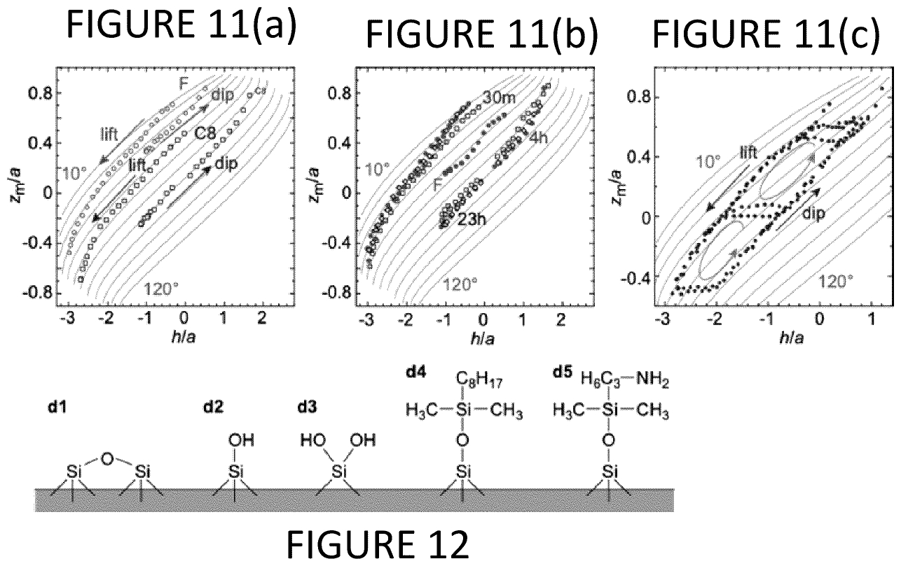

FIGS. 11(a)-11(c) are cyclic epipedograms (CEs) in water. All of the spheres were treated with Fenton's reagent before reaction with chlorosilane or ethoxysilane. FIG. 11(a) is a plot of zₘ/a vs h/a for a sphere (radius a=284 μm) treated with Fenton's reagent, followed by octyldimethylchlorosilane (C8DMCIS). Gray lines indicate CE for constant contact angles from 10 to 120° at 10° intervals (FIG. 6).FIG. 11(a) shows CE for a microsphere hydroxylated with Fenton's reagent (F) and the same microsphere after reaction with octyldimethylchlorosilane (C8). Figures S4 and S5 in the Appendix show excerpts of still images for epipedography of the two microspheres. A dip track and a lift track constitute two branches of the whole cycle. Below is a brief description of the cycle.

As the microsphere touched water (h/a≅−1), the water line settled after a while. Further dipping (h/a increases) raised the water line (zₘ/a increased). The point in the diagram moved up and right, forming a dip track along one of the iso-CA lines; the F sphere's CA was ˜35°, and C8 sphere had CA≅80°, in agreement with past reports. (See, e.g., the article, Hasan, A.; Pandey, L. M., “Kinetic studies of attachment and re orientation of octyltriethoxysilane for formation of self-assembled monolayer on a silica substrate,” Mat. Sci. Eng. C 2016, 68, 423-429 (incorporated herein by reference).) A longer reaction time (ours was 30 minutes) may have resulted in a greater CA, as reported by Fadeev and McCarthy. (See, e.g., the article, Fadeev, A. Y.; Mccarthy, T. J., “Trialkylsilane Monolayers Covalently Attached to Silicon Surfaces: Wettability Studies Indicating that Molecular Topography Contributes to Contact Angle Hysteresis,” Langmuir 1999, 15, 3759-3766, (incorporated herein by reference).) Toward the end of the dip track, the apparent CA decreased. For the F microsphere that is hydrophilic, the water line was always above the water plane until the microsphere submerged. In contrast, the C8 microsphere depressed the water plane, and the present inventors had to change the focus onto the microsphere in water to observe the water line.

After complete submerging, the sphere was lifted. The sphere had to be positioned higher (h/a is less) in the lifting track compared with the dipping track, for the same level of water line. Subsequently continued lifting gave a long stretch of uninterrupted viewing of the water line, until the sphere released water. The point in the figure moved left and down. The apparent CA increased during the lift, indicating that the surface became more hydrophobic as more of the sphere's surface was exposed to air. The apparent CA changed from ˜10 to ˜40° for the F sphere, and from ˜50 to ˜70° for the C8 sphere. It is interesting that the CA at the point of dumping water is close to the one at the microsphere's touching water for each of the two microspheres.

When the microsphere dumped water, a hanging droplet formed at the bottom. The C8 microsphere had a compact droplet, and the F microsphere had a broad droplet, almost covering the lower hemisphere. Immediately after dumping water, the microsphere was lowered again. The water droplet evaporated to some extent, before the microsphere touched water for a second time. The rise of the water line was similar to the one in the first touch.

When the microsphere touches water, it takes 0.2-1.5 s for the water line to settle, depending on the surface. If the settling takes time, the microsphere may have moved down a bit, and h/a for the first point in the dip track may be slightly greater than −1. If the water plane has been lifted by charges of the microsphere, h/a for the first point is slightly less than −1.

The difference between the contact angle of the F microsphere and that of the C8 microsphere is reasonable, but how much the two tracks of CE are away from each other in each microsphere draws our attention. The C8 microsphere shows a greater difference than the F microsphere does. The C8 microsphere is more hydrophobic when dipped than it is when it is in water and lifted. It is also the case with the F microsphere, but to a lesser extent. The present inventors consider that octyl chains on the C8 sphere caused the difference. Hydroxylated silica surface consists of hydrophilic silanols (—SiOH) (d2 and d3 in FIG. 12) and hydrophobic siloxanes (—SiOSi—) (d1); the siloxane bond is nonpolar. The fraction of silanols that react with chlorosilane is far less than 100%, making the surface consist of silanols, siloxanes, and octyl moieties. When the C8 microsphere is left in air, the octyl chains will cover the silanols to minimize exposure of the microsphere surface to hydrophobic air. In water, in contrast, octyl chains will cover siloxanes to maximize exposure of polar silanols to water. The present inventors consider that this conformity of surface moieties to the changing environment causes the contact angle to be different between the two tracks, and with a changing water coverage of the sphere surface within each track. The conformity is a lot less for the F microsphere, but not zero, and the present inventors consider that short silanols on the surface caused the observed difference.

The present inventors confirmed that the movement of the microsphere is sufficiently slow by running the CE at different speeds. Section 6 in the Appendix shows the results for a microsphere treated with Fenton's reagent, followed by butyldimethyl-chlorosilane. A faster movement gave almost an identical CE. This method will also allow investigation of dynamic wettability (See, e.g.: the article, De Coninck, J.; de Ruijter, M. J.; Voue, M., “Dynamics of wetting,” Curr. Opin. Colloid Interface Sci. 2001, 6, 49-53 (incorporated herein by reference.); and the article, Chen, L.; Bonaccurso, E., “Effects of surface wettability and liquid viscosity on the dynamic wetting of individual drops,” Phys. Rev. E 2014, 90, No. 022401 (incorporated herein by reference).) by rapidly moving the microsphere; if necessary, a microscope with a higher frame rate should be used.

Next, we show an example of monitoring a reaction by CE. More specifically, FIG. 11(b) illustrates a CE for a microsphere (radius=270 μm) treated in a solution of aminopropyldimethylethoxysilane (APDMEoS) in toluene for different periods (F=0, 30 min, 4 h, 23 h). A silica microsphere, first hydroxylated with Fenton's reagent, was immersed in a solution of aminopropyldimethylethoxysilane (APDMEoS) in toluene (10 wt %). During the reaction, the microsphere was taken out of the solution, rinsed in toluene, then in acetonitrile, and then in water for video recording of CE. Subsequently, the microsphere was returned to the solution to continue the reaction. FIG. 11(b) shows epipedograms for the videos after 0 min, 30 minutes, 4 hours, and 23 hours in the same solution. The F microsphere (0) was slightly more hydrophobic in the dip track than that shown in FIG. 11(a), but the lift track was similar. After 30 min in the solution, the microsphere became more hydrophobic, especially in the dip track. Subsequent changes in the reaction were slow and small; the dip track increased its hydrophobicity, but the lift track restored the hydrophilicity of the F sphere. The conformity of the surface-attached aminopropylsilane moieties to the surroundings increased as the reaction progressed. (See, e.g., the articles: Howarter, J. A.; Youngblood, J. P., “Optimization of Silica Silanization by 3-Aminopropyltriethoxysilane,” Langmuir 2006, 22, 11142-11147 (incorporated herein by reference); and Smith, E. A.; Chen, W., “How To Prevent the Loss of Surface Functionality Derived from Aminosilanes,” Langmuir 2008, 24, 12405-12409 (incorporated herein by reference).) The attached moiety consists of extremely hydrophilic amine (likely protonated) and hydrophobic hydrocarbon (trimethylene+dimethyl). Obviously, this two-part moiety can expose a hydrophilic side or a hydrophobic side, depending on the surroundings. The Janus characteristics became more prominent with increasing reaction time, and hence increasing surface density of the moieties.

Another example of the same reaction is described, but starting with a less hydrophilic F microsphere. The CE is shown in FIG. S7 of the Appendix.

The cyclic nature of CE is well demonstrated by the next experiment shown in FIG. 11(c). More specifically, FIG. 11(c) is a plot of CE for a microsphere (a=283 μm) treated with APDMEOS for 49 h. The dipping was reversed before the microsphere submerged; the lifting was reversed before the microsphere dumped water. The moving direction was reversed several times. Another APDMEoS-treated microsphere was employed. Dipping was interrupted before the microsphere submerged, followed by changing the direction of microsphere's movement. Likewise, in the lifting track, the microsphere's movement was reversed before it released water. Section 8 in the Appendix describes details of the movement of the microsphere, and concomitant movement of the point in the CE. In short, when the sphere's movement was reversed, the water line on the microsphere barely moved before the point in the diagram hit the other track of CE, either from left or from right. After hitting the track, the point resumed tracking either the lift track downward or the dip track upward. The cyclic nature of CE is more evident than the one that consists of two separate tracks.

FIG. 12 illustrates atomic structures of silica surface. Just prepared and hydroxylated microspheres have different degrees of d1, d2, and d3. Reaction with C8DMCIS and APDMES convert some of silanols into d4 and d5, respectively.

### § 5.6 CONCLUSIONS

In conclusion, the present inventors have introduced cyclic epipedography for surface characterization by dipping a microsphere into a liquid and lifting it from the liquid while monitoring the level of the liquid line on the sphere. The present inventors demonstrated that the method can estimate the contact angle at different stages of wetting in the liquid and monitor the progress of a chemical reaction. The present inventors have also shown that attaching a long alkyl chain or an amphiphilic chain makes the surface conform to the environment. The use of CE with a microsphere should be useful to investigate various phenomena including chemical reactions, complexation, and binding on silica surfaces. The use of CE will lead to a better understanding of silanization methods that are the starting point for many sensors and devices.

What is claimed is:

1. A method for monitoring a chemical process, the method comprising:
a) receiving a previously determined set of epipedographs associated with the chemical process;
b) obtaining a current epipedograph of the chemical process;
c) comparing the current epipedograph with the set of epipedographs received to determine a contact angle; and
d) inferring a current state of the chemical process based on the contact angle.

2. The method of claim 1, further comprising:
e) repeating the acts of (b) obtaining a current epipedograph of the chemical process, (c) comparing the current epipedograph with the set of epipedographs received to determine a contact angle, and (d) inferring a current state of the chemical process based on the contact angle.

3. The method of claim 1, wherein the act of obtaining a current epipedograph of the chemical process includes:
1. dipping a microsphere or rod having a surface provided with a first biochemical substance into water or a solution having a second biochemical substance, and lifting the microsphere or rod from the solution,
2) obtaining, repeatedly, during the dipping and lifting, paired measurements of (i) the vertical position (Zₘ) of a circular slice of the microsphere or rod at a waterline defined at a top or a bottom of a meniscus of the solution on the microsphere or rod, and (ii) a height (h) of the water plane away from the microsphere or rod, and
3) determining the current epipedograph from the paired measurements obtained.

4. The method of claim 3, wherein the microsphere or rod has a smooth surface.

5. The method of claim 1, wherein the microsphere or rod has a smooth surface.

6. The method of claim 3, wherein a diameter of the microsphere or rod is from approximately from 0.2 mm to 2 mm.

7. The method of claim 3, wherein the solution is held in a transparent container, and
wherein inner walls of the transparent container have been treated to reduce a meniscus formed by the solution with respect to transparent container.

8. The method of claim 7, wherein the transparent container is a square glass cuvette.

9. The method of claim 3, wherein the solution is held in a transparent container, and
wherein the inner walls of the transparent container have been chemically modified to have the solution-air interface at around 90 degree to the surface.

10. The method of claim 9, wherein the chemically modifying agent is a silane with hydrophobic functionality.

11. The method of claim 1, wherein the microsphere or rod is a microsphere.

12. The method of claim 1, wherein the microsphere or rod is a silica microsphere.

13. The method of claim 1, wherein a surface of the microsphere or rod is functionalized with an aminopropyl group or compound or another silane coupling agent.

14. Apparatus for monitoring a chemical process, the apparatus comprising:
a) a microsphere or rod having a surface provided with a first biochemical substance;
b) a transparent container for containing water or a solution having a second biochemical substance;
c) a motor for dipping and lifting the microsphere or rod from a solution held in the transparent container; and
d) a microscope positioned outside of and adjacent to the transparent container and held horizontally, configured to obtain, repeatedly, during the dipping and lifting, paired measurements of (i) vertical position (Zₘ) of a circular slice of the microsphere or rod at a waterline defined at a top or a bottom of a meniscus of water or the solution on the microsphere or rod, and (ii) a height (h) of the water plane away from the microsphere or rod.

15. The apparatus of claim 14, further comprising:
a stem that mechanically couples the microsphere or rod with the motor.

16. The apparatus of claim 14, wherein the microsphere or rod has a smooth surface.

17. The apparatus of claim 14, wherein a diameter of the microsphere or rod is from approximately 0.2 mm to 2 mm.

18. The apparatus of claim 14, wherein the microsphere or rod is a microsphere.

19. The apparatus of claim 14, wherein the microsphere or rod is a silica microsphere.

20. A non-transitory computer-readable storage medium storing processor-executable code which, when executed by a least one processor, causes the at least one processor to perform a method including:
a) receiving a previously determined set of epipedographs associated with a chemical process;
b) obtaining a current epipedograph of the chemical process by
1) controlling a motor to dip a microsphere or rod having a surface provided with a first biochemical substance into water or a solution having a second biochemical substance, and lift the microsphere or rod from the solution,
2) causing a microscope to obtain, repeatedly, during the dipping and lifting, paired measurements of (i) the vertical position (Zₘ) of a circular slice of the microsphere or rod at a waterline defined at a top or bottom of a meniscus of the solution on the microsphere or rod, and (ii) a height (h) of the water plane away from the microsphere or rod, and
3. determining the current epipedograph from the paired measurements obtained;
c) comparing the current epipedograph with the set of epipedographs received to determine a contact angle; and
d) inferring a current state of the chemical process based on the contact angle.
